(19) United States
(12) Patent Application Publication
(10) Pub. No.: US 2022/0269754 A1
(43) Pub. Date: Aug. 25, 2022

(54) DECENTRALIZED SYSTEM AND METHOD FOR ASSET REGISTRY AND AUTHENTICATION

(71) Applicant: bythedirectpath LLC, Lewes, DE (US)

(72) Inventors: Roberto Cardo Sanchez, Valladolid (ES); Ismael Dominguez Garcia, Valladolid (ES)

(21) Appl. No.: 17/181,063

(22) Filed: Feb. 22, 2021

(51) Int. Cl. G06F 21/10; H04L 9/32; H04L 9/06

(52) U.S. Cl. CPC G06F 21/105; H04L 9/3239; H04L 9/0643; H04L 2209/38

(57) ABSTRACT

The present disclosure provides a decentralized system and method for Asset registry and authentication in a public blockchain. Each Asset represented by a Non-Fungible Token (NFT) as the unique, immutable, and irrefutable fingerprint, which upon creation is recorded in a block of a public blockchain architecture. The data can include authorship, ownership, transfer history and the date of creation of the Asset for operations such as priority decisions with respect to other Assets or infringement cases. Once registered the owner will be granted a right to use an official symbol or logo alongside the Asset as proof of the registration and validity of the Asset to warn/inform any individual that the asset has been registered in a public blockchain.

### FIELD OF USE

The present invention relates generally to managing rights to assets and more specifically to a decentralized infrastructure and system for registering and authenticating assets utilizing blockchain rights ledgers.

### BACKGROUND

A blockchain is a computer-implemented decentralized, consensus-based, distributed system made up of blocks which in turn are made up of transactions. Each block contains a hash of the data contained in the previous block which acts as a digital fingerprint so that the blocks become chained together to create a permanent, immutable record of all transactions which have been written to the blockchain since its inception. The most widely known application of blockchain technology is the Bitcoin ledger, however many other blockchain implementations have been proposed and developed. In particular, blockchain infrastructures are uniquely suited to tokenizing assets with digital tokens since the data held in the chain is immutable and tokens cannot be copied or tampered with.

One field where the immutability of data is particularly important is the registration of intellectual property (IP) assets. The date at which the IP asset was generated, the authorship of the IP asset, and the ownership of the rights generated by the IP asset can all have enormous financial consequences. Currently, the registration and transfers of such assets are managed via separate complex and slow-moving legal systems that take up vast amounts of resources and are still prone to human error. It would be advantageous to be able to immediately determine the origin, ownership, and date of creation or transfer of an IP asset by checking immutable transactions stored on a public blockchain.

Other fields where registration of assets on a public blockchain include real estate, movable property, works of art, software, merchandise, contractual agreements, and the management of private capital. It is within this context that the present invention is provided.

### SUMMARY

The present disclosure provides a method of registering immutable engraving data, relating to particular Assets on a blockchain, each represented by a Non-Fungible Token (NFT) which upon creation is recorded in a block of a public blockchain architecture alongside all of the information relating to the represented Asset. The data can include authorship, ownership, transfer history and the date of creation of the Asset for operations such as priority decisions with respect to other Assets or infringement cases.

Once registered, the owner of the asset may be granted the right to us an official symbol or logo (for example, the logo “BC”) alongside the Asset as proof of the validity of the Asset to warn/inform others that the asset is registered. Any person wanting to check the validity of this registration may find all the legal evidence for the registration immutably stored on the public blockchain.

A system comprising a blockchain architecture of distributed ledgers for implementing the method is also provided. Thus, according to a first aspect of the present disclosure, there is provided a method for recording and validating ownership rights in an Asset, the method comprising: receiving, by a processor, an Asset registration request from a natural or legal person, the request containing an evidence of identity associated with the natural or legal person; generating, by a processor, an Asset record having a fingerprint comprising a hash of a digital representation of the Asset; creating a Non-Fungible Token representing the unique, immutable, and irrefutable fingerprint of the registration of the asset in conjunction with evidence of authorship and creation; and; communicating, by the processor, with one or more nodes of a peer-to-peer network to generate an entry in a public ledger by performing the steps of: generating at least one Asset issue record for the Non-Fungible Token associated with the natural or legal person; engraving the Asset issue record comprising the Non-Fungible Token on the public ledger; and granting an owner of the at least one Asset the right to use an official logo representing that the asset is registered in a public blockchain.

In some embodiments, the evidence of identity of the natural or legal person is a public key of a wallet stored on the public ledger and owned by the natural or legal person. In some embodiments, the Asset represents a copyright, trademark, patent, or design right. In other embodiments, the Asset may represent real estate, movable property, works of art, software, merchandise, contractual agreements, or private capital.

In some embodiments, the method further comprises receiving a transfer of ownership request from the natural or legal person, verifying the identity of the receiving natural or legal person, and upon successful identity verification, communicating with the one or more nodes of the peer-to-peer network to generate an Asset transfer of ownership record on the public ledger and displaying the updated Asset.

### BRIEF DESCRIPTION OF THE DRAWINGS

Various embodiments of the invention are disclosed in the following detailed description and accompanying drawings.

FIG. 1 illustrates a network diagram of a decentralized Asset registration and management system for in accordance with the present disclosure.

FIG. 2 illustrates a flow diagram of an example method according to the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a decentralized, distributed digital rights and assets ledger that documents the registration of assets and their subsequent transfers of ownership from creators to other legal persons. In many embodiments, the rights ledger is stored, modified and maintained on several independent nodes and trust is established by rules on the format on the ledger rather than the source and origin of the information. In such embodiments, the rules are established with cryptographic principles that make modification of the data difficult.

No centralized third party of trust is needed for transactions involving Asset authenticity verification, distribution, selling, data-tracking, metrics analytics, and/or auditing. Asset owners and creators are motivated to register and authenticate newly generated or transferred assets in the blockchain rights and assets ledger. The blockchain rights ledger having a record of a creation or transfer of an right evidences that right as authentic, and the owner of the asset is granted the right to use an official logo representing this to inform and warn any individual that the asset is registered on a public blockchain rights ledger that the right is thus valid, discouraging them from infringing the right and possible encouraging them to request a license or formal transfer.

A decentralized digital assets ledger system can allow creators to increase control of their works, reduce transaction costs and friction, i.e., the ability to get to market faster and with less cost by removing the need for complex legal systems and proprietary rights management systems with large network infrastructures.

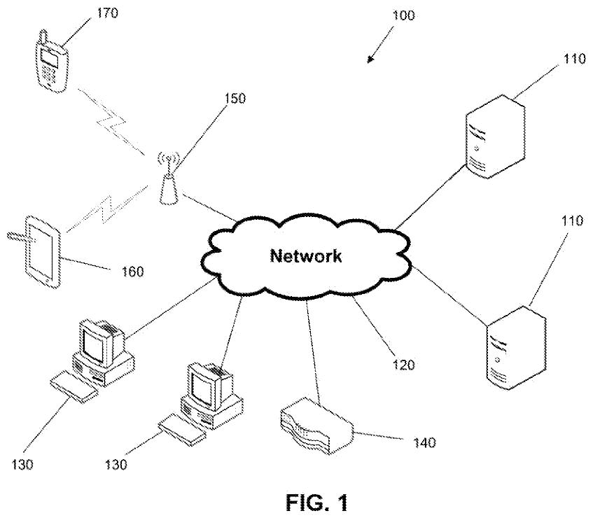

Referring to FIG. 1, an example configuration of a decentralized digital assets ledger system 100 in accordance with the present disclosure is shown.

The digital rights and assets ledger system 100, includes a blockchain management device 110 that can communicate with one or more other nodes via a wireless network 120. Additionally, the digital rights and assets ledger system 100 may interact with a plurality of other devices that may run on hardware such as personal computers 130, set-top boxes 140, mobile phones 170, personal computing devices 160, some of which may communicate on the network 120 via a wireless access point 150. This enables users to easily query the public blockchain assets ledger to, for example, determine the validity and other details of an registered asset, and may also allow them to send requests for registration of a new asset or a transfer of ownership.

In one example, the digital rights and assets ledger system 100 may require a blockchain management device 110 configured to create an initial genesis block in a ledger file. This new ledger file may be transmitted over the network 120 to other nodes including devices 130, 140, 160, 170 and other blockchain management devices 110.

The digital rights ledger system 100 is decentralized in that entire copies of a particular ledger file are stored on multiple nodes. Participating nodes may utilize a copy of the ledger and make the transaction history available for download to others per default via network 120 such as by utilizing peer-to-peer protocols.

Assets that have been successfully registered in the ledger have been issued may be replicated to the various devices in the network. Furthermore, the owner of such registered rights or assets may be granted the right to use an official logo confirming the authenticity of the asset. In one example the symbol/logo is a simple text “BC” displayed next to the Asset. This provides the technical advantage of conveying that a right is authentic in a simple manner such that users querying the network can scan large numbers of Assets for validity in a short amount of time.

The registration speed and visibility of registrations and transfers are thus both greatly improved as compared with traditional Asset registration systems. The low cost nature of the process also makes it suitable for use by low-income countries that struggle with setting up large and complex asset right management infrastructure.

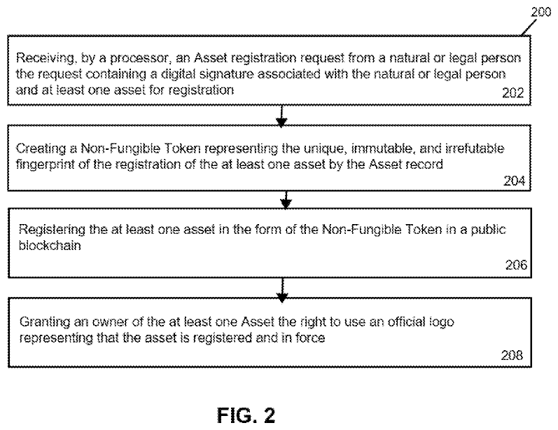

Referring to FIG. 2, a flow diagram of an example method for recording and validating ownership rights in an Asset 200 according to the present disclosure is shown, wherein a Non-Fungible Token is issued for the registered asset.

Referring to FIG. 2, a flow diagram of an example method for recording and validating ownership rights in an Asset 200 according to the present disclosure is shown.

Asset Registry and Authentication (also referred to herein as immutable engraving data) in a public blockchain that utilizing a non-fungible token (NFT) as the unique, immutable and irrefutable fingerprint of the asset in the registration process allows the commercialization of the ownership of an original asset and the ability to maintain or sell its creative license, with which royalties can be received for its commercial uses. Once registered the owner will be granted a right to use an official symbol or logo alongside the Asset as proof of the registration and validity of the Asset to warn/inform any individual that the asset has been registered in a public blockchain.

Thus, in a first step 202, the method comprises receiving, by a processor, an Asset registration request from a natural or legal person, the request containing an evidence of identity associated with the natural or legal person and assets for registration on a public blockchain. This request may be sent by devices such as devices 130-170 described in relation to FIG. 1. The evidence of identity of the natural or legal person may a public key of a wallet stored on the public ledger and owned by the natural or legal person. The Asset may represent any kind of asset.

In a second step 204, the method comprises generating, by a processor, a Non-Fungible Token which is a digital fingerprint representing the unique, immutable, and irrefutable fingerprint of the asset.

In a third step 206, the method comprises communicating, by the processor, with one or more nodes of a peer-to-peer network to register the asset in a public blockchain.

In a fourth step, 208, the method comprises granting an owner of the at least one Asset the right to use an official logo representing that the asset is registered, wherein the logo is represented by the symbol (BC) next to the asset.

The method may further comprise receiving a transfer of ownership request from the natural or legal person, verifying the identity of the receiving natural or legal person, and upon successful identity verification, communicating with the one or more nodes of the peer-to-peer network to generate an Asset transfer of ownership record on the public ledger and displaying the updated Asset.

While having been described specifically with respect to a centralized server linked to a distributed network of nodes, it should be understood that the operations described herein may be carried out by any processor comprising a distributed element. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below. In addition, the operations shown in the figures, or as discussed herein, are identified using a particular nomenclature for ease of description and understanding, but other nomenclature is often used in the art to identify equivalent operations.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the blockchain registration method and system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for recording and validating ownership rights in an Asset, the method comprising:
receiving, by a processor, an Asset registration request from a natural or legal person, the request containing a digital signature associated with the natural or legal person;
creating a Non-Fungible Token which is a digital fingerprint containing all data relating to the asset including proofs of authorship and ownership, the Non-Fungible Token thereby representing the unique, immutable, and irrefutable fingerprint of the asset;
communicating, by the processor, with one or more nodes of a peer-to-peer network to generate an entry in a public ledger; and;
granting an owner of the at least one Asset the right to use an official logo representing that the asset is registered in a public Blockchain.

2. A method according to claim 1, wherein the digital signature of the natural or legal person is any form of proof of identity.

3. A method according to claim 1, wherein the Asset represents a copyright, trademark, patent, or design right.

4. A method according to claim 1, wherein the Asset represents real estate, movable property, works of art, software, merchandise, contractual agreements, or private capital.

5. A method according to claim 1, wherein the method may further comprise receiving a transfer of ownership request from the natural or legal person, verifying the identity of the receiving natural or legal person, and upon successful identity verification, communicating with the one or more nodes of the peer-to-peer network to generate an Asset transfer of ownership record on the public ledger and displaying the updated Asset.

6. A method according to claim 1, wherein each Asset registered on the public ledger may contains one or more of the date of creation of the Asset and the identity of the author/s of the Asset.
